(19) United States
(12) Patent Application Publication
(10) Pub. No.: US 2018/0333656 A1
(43) Pub. Date: Nov. 22, 2018

(54) Fluid Treatment System and Method of Use Utilizing Compressible Oil Coalescing Media

(71) Applicant: Jarid Hugonin, Lafayette, LA (US)

(72) Inventor: Jarid Hugonin, Lafayette, LA (US)

(21) Appl. No.: 15/600,277

(22) Filed: May 19, 2017

(51) Int. Cl. B01D 17/04; C02F 1/40

(52) U.S. Cl. CPC B01D 17/045; C02F 2103/10; C02F 1/40

(57) ABSTRACT

A variable oil field fluid treatment system and method of use which utilizes a pump, a compressible media for coalescing and removal of oil unit, a vertical or horizontal polishing-unit and/or combinations therein.

### CROSS-REFERENCE TO RELATED APPLICATIONS

Not applicable.

### STATEMENT REGARDING FEDERALLY SPONSORED RESEARCH

Not applicable.

### BACKGROUND

The present Invention generally relates to the treatment of well fluids, produced water, and oilfield waste water. Relevant background information is discussed below.

The U.S. Environmental Protection Agency (EPA) generally defines an injection well as a bored, drilled, or driven shaft, or a dug hole that is deeper than it is wide, or an improved sinkhole, or a subsurface fluid distribution system. Well construction depends on the injection fluid injected to the depth of the injection zone. Deep wells that are designed to inject hazardous wastes or carbon dioxide deep below the Earth's surface have multiple layers of protective casing and cement, whereas shallow wells injecting non-hazardous fluids into or above drinking water sources are more simply constructed.

In some waste water disposals, treated waste water is injected into the ground between impermeable layers of rocks to avoid polluting fresh water supplies or adversely affecting the quality of receiving waters. Injection wells are usually constructed of solid walled pipe to a deep elevation in order to prevent injectate from mixing with the surrounding environment.

Injection wells can be considered to be one method for disposal of treated waste water. Unlike outfalls, or other direct disposal techniques, injection wells utilize the Earth as a filter to further clean the treated wastewater before it reaches the receiving water. This method of waste water disposal also serves to spread the injectate over a wide area, further decreasing environmental impacts.

There are, in general. disposals for well injections on platforms at sea, and on land, when water does not meet customer specifications. Some of these waters are disposed to a boat which transports the materials to land for treatment and disposal. Some companies dispose to tanks on platforms, then transport, treat and dispose of the water on land. In other variations, there are pumps used to pump well injections into pipelines for transport to salt caverns on land.

Salt caverns are cavities, or chambers, formed in underground salt deposits. Although cavities may naturally form in salt deposits, some caverns are intentionally created by humans for specific purposes, such as for storage of petroleum products or disposal of wastes.

Some removal solutions involve treatment with absorption technologies for discharge overboard from the platform. Some utilize hydrocyclones as well, or utilize both technologies in treatment procedures. Some systems treat with coalescing technologies for discharge overboard. Some systems treat with diatomaceous earth technologies. Some systems treat with membrane technologies. Some systems utilize centrifuge and/or absorption or coalescing technologies. Some removal solutions use conventional solids filtration. Some removal solutions utilize diffused gas flotation or induced gas flotation technologies.

Within some water-treatment equipment, in which the energy input to the fluid is very small, the process of coalescence takes place if enough residence time is provided; that is, small oil droplets collide and form bigger droplets. Because of the low energy input, these droplets are not dispersed. Coalescence can also occur the pipe downstream of pumps and control valves. However, in such instances, the process of dispersion will govern the maximum size of stable oil droplets that can exist. For normal pipe diameters and flow velocities, particles of 500 to 5000 μm are possible.

A centrifugal water-oil separator centrifugal oil-water separator or centrifugal liquid-liquid separator is a device designed to separate oil and water by centrifugation. It generally contains a cylindrical container that rotates inside a larger stationary container. The denser liquid, usually water, accumulates at the periphery of the rotating container and is collected from the side of the device, whereas the less dense liquid, usually oil, accumulates at the rotation axis and is collected from the center.

Conventional technologies involved with water treatment often remove and contain oil and grease which utilize expensive chemicals or consumable medias that requires disposal on land. These consumable media technologies become cost prohibitive as they consume the oil to be removed and still require further disposal. Traditional oil absorbing media needs to be disposed once it is utilized, as it becomes a waste product.

### Produced Water Background

Produced water is water trapped in subsurface formations which is brought to the surface along with oil or gas. Produced water contributes the largest volume of the waste stream associated with oil and gas production. Some conventional methods that are used process produced water through a battery of separation vessels to separate natural gas and oil from water. Typically, these methods use high, intermediate and low pressure separators, water skimmers, bulk oil treaters, liquid-liquid hydro cyclones, flotation vessels, and if needed, tertiary technologies such as walnut shells, solids filtration, activated carbon or other polishing medias.

Produced water is chemically very complex. The process of producing and processing produced water causes changes in temperature and pressure in the produced water. There can also be an addition of treating chemicals, along with the presence of coproduced gas, oil, and likely solids. Produced water may contain soluble and insoluble organic compounds, dissolved solids, production chemicals (corrosion inhibitors, surfactants etc.) and solid particles due to leaching of rocks and corrosion of pipelines. Some known methods available for treating produced water are physical, chemical, biological and membrane treatment processes.

### Slop Water Background

Produced water that does not meet discharge or injection criteria is typically called “slop water”. A Floating Production, Storage and Offloading (“FPSO”) unit is a floating vessel used by the offshore oil and gas industry for the production and processing of hydrocarbons, and for the storage of oil. A FPSO vessel is designed to receive hydrocarbons produced by itself, or from nearby platforms, or subsea template, process them, and store oil until it can be offloaded onto a tanker or less frequently, transported through a pipeline. FPSOs are preferred in frontier offshore regions as they are easy to install, and do not require a local pipeline infrastructure to export oil. FPSOs can be a converted oil tanker or can be a vessel built specially for the application.

Slop waters are generated from off specification produced water not suitable for overboard discharge and oily water skimmings from flotation technologies and hydro cyclone rejects. Skimmings, or reject, are a percentage of the fluid that is not sent out of the discharge of the equipment, but is recycled back into the front of the total process. The reject is mostly water so it will be recycled back into the total system further upstream.

Slop water can be stored in the compartments within the hull of the ship for days, weeks, months or even years. During this timeframe, chemicals are added to control corrosion, bacteria and H₂S content of the slop water; this causes emulsions to be formed due to the fine solids generated in this treatment. Due to these emulsions, hydrocarbons will not typically be separated from the slop water by gravity separation.

Increased volumes of slop water in tanks reduces the oil storage capacity of these facilities significantly, affecting the economics of an operation. Since the same storage tanks that are design to hold bulk oil will also hold slop water, the more slop water that is in the tanks, the less amount of slop water can be stored. Once the storage tanks are full, whether it is with slop water or oil, the oil will need to be off-loaded.

### Deck Drainage Water Background

Deck drainage water, in oil and/or gas drilling and production, comes from collected rainwater and miscellaneous fluids such as oils and greases on a deck of a platform. Typically, a number of drains are spread throughout one or more decks of the offshore platform, especially on portions of the decks which are Open and therefore exposed to the weather. Since the rainwater washes any spilled oil or grease off of the deck and into the drains, the rainwater cannot be passed directly into the body of water beneath the platform. Instead, the collected rainwater must be treated so as to separate the oil from the water until the percentage of oil in the water reaches a acceptable level.

Presently, laws, such as the Clean Water Act, prohibits discharging “pollutants” through a “point source” into a “water of the United States” unless they have an NPDES permit. The permit will contain limits on what an entity can discharge, monitoring and reporting requirements, and other provisions to ensure that the discharge does not hurt water quality or people's health. In essence, the permit translates general requirements of the Clean Water Act into specific provisions tailored to the operations of each person discharging pollutants. Typically (as the governing country's ordinances permit), as little as twenty-nine parts per million of oil in water is permitted in the water to be returned to the body of water beneath the platform.

### Polymer Flood Background

After primary and secondary recovery (below), chemical enhanced oil recovery technology can extract almost 20% of additional oil from a reservoir. Polymer flooding is an established chemical enhanced oil recovery process, where an aqueous polymeric solution with a viscosity closely matched to the oil is injected to enhance the mobility of fluid in the reservoir. The fluid injection profile is improved through the addition of polymers, making it more consistent and stable, enhancing the displacement efficiency.

During the primary recovery stage, reservoir drive comes from a number of natural mechanisms. These include: natural water displacing oil downward into the well, expansion of the natural gas at the top of the reservoir, expansion of gas initially dissolved in the crude oil, and gravity drainage resulting from the movement of oil within the reservoir from the upper to the lower parts where the wells are located.

When underground pressure in the oil reservoir is sufficient to force the oil to the surface, all that is necessary is to place a complex arrangement of valves on the well head to connect the well to a pipeline network for storage and processing. Sometimes pumps, such as beam pumps and electrical submersible pumps (ESPs), are used to bring the oil to the surface; these are known as artificial lifting mechanisms.

Over the lifetime of the well, the pressure falls and at some point, here is insufficient underground pressure to force the oil to the surface. After natural reservoir drive diminishes, secondary recovery methods are applied. Secondary recovery methods can rely on the supply of external energy into the reservoir the fours of injecting fluids to increase reservoir pressure, hence replacing or increasing the natural reservoir drive with an artificial drive. Secondary recovery techniques increase the reservoir's pressure by orate injection, natural gas reinjection and gas lift, which injects air, carbon dioxide or some other gas into the bottom of an active well, reducing the overall density of fluid in the wellbore.

The performance of the polymeric solutions used largely relies on their theological properties and therefore, detailed theological characterization under relevant conditions supports performance optimization. In addition to the polymers, surfactants can also be added to add additional extraction capabilities. Polymer flooding will increase the viscosity of the water and surfactants will create a tighter oil water emulsion, while the water returning to the surface will be difficult for standard water treatment equipment to maintain efficiencies in recapture.

### Produced Oil Wet Solids Removal

Fine solid particles present in crude oil are capable of effectively stabilizing emulsions. The effectiveness of these solids in stabilizing emulsions depends on factors such as: solid particle size, interparticle interaction, and wettability of the solids.

Solid particles stabilize emulsions by diffusing to the oil/water interface, where they form rigid films that can sterically inhibit the coalescence of emulsion droplets. Furthermore, solid particles at the interface may be electrically charged, which may also enhance the stability of the emulsion. Particles must be much smaller than the size of the emulsion droplets to act as emulsion stabilizers. Typically, these solid particles are submicron to a few microns in diameter.

The wettability of the particles plays an important role in emulsion stabilization. Wettability is the degree to which a solid is wetted by oil or water when both are present. If the solid remains entirely in the oil or water phase, it will not be an emulsion stabilizer. For the solid to act as an emulsion stabilizer, it must be present at the interface and must be wetted by both the oil and water phases. In general, oil-wet solids stabilize a water-in-oil emulsion. Oil-wet particles preferentially partition into the oil phase and prevent the coalescence of water droplets by steric hindrance. Similarly, water-wet solids stabilize a water-continuous or an oil-in-water emulsion.

When solids are wetted by the oil and water (intermediate wettability), they agglomerate at the interface and retard coalescence. These particles must be repositioned into either the oil or water for coalescence to take place. This process requires energy and provides a barrier to coalescence.

The effectiveness of colloidal particles in stabilizing emulsions depends largely on the formation of a densely-packed layer of solid particles (film), at the oil/water interface. This film provides steric hindrance to the coalescence of water droplets. The presence of solids at the interface also changes the theological properties of the interface that exhibits viscoelastic behavior. This affects the rate of film drainage bets eon droplets and also affects the displacement of particles at the interface. It has also been demonstrated that for asphaltenes and waxes to be effective emulsifiers, they must be present in the form of finely divided submicron particles

### SUMMARY

In some embodiments of the present invention, the present invention is a system and method for treatment of oil & gas production fluids utilizing a compressible media for coalescing hydrocarbons. In some embodiments, the present Invention treats fluids to satisfy customer and regulatory limits for overboard disposal, discharge to environment on land, transported to water treatment facility on land, or waste disposal through well injection. In some embodiments, the present process will successfully meet overboard, disposal or injection well requirements with varying contamination levels of oil & grease (free and emulsified) and suspended solids. In some embodiments, the present process carbon footprint for similar flowrates is significantly lower than conventional technologies such, as water skimmers, bulk oil treaters, liquid-liquid hydrocyclones, flotation vessels and absorption medias. In some embodiments, the present process utilizes minimal and often zero consumables compared to conventional technologies.

In some embodiments, the present invention is a system for treating slop water comprising: FPSO fluid compartments; a pump; a compressible oil coalescing and removal unit, and if needed a vertical or horizontal polishing media unit; wherein fluid passed into said FPSO fluid compartments is pumped via said pump into said compressible oil coalescing and removal unit for oil coalescing and removal; if needed said fluid is then passed into said vertical or horizontal polishing unit; and wherein water derived from said fluid from FPSO fluid compartments that is pumped via said compressible oil coalescing and removal unit for oil coalescing and removal; if needed said fluid is then passed into said vertical or horizontal polishing media unit and is discharged and oil derived from said process is returned to user for further use.

In some embodiments, the present invention is a system for treating deck drainage comprising: FPSO fluid compartments; a pump; a compressible oil coalescing and removal unit; and if needed a vertical or horizontal polishing media unit; wherein fluid passed into said FPSO fluid compartments is pumped via said pump into said compressible oil coalescing and removal unit for oil coalescing and removal; said fluid if needed is then passed into said vertical or horizontal polishing unit; and wherein water derived from said fluid from FPSO fluid compartments is pumped via said compressible oil coalescing and removal unit for oil coalescing and removal; if needed said fluid is then passed through. said vertical or horizontal polishing media unit and is discharged and oil derived, from said process is returned to user for further use.

In some embodiments, the present invention is a system for treating FOR Polymer Flood & ASP comprising: FPSO fluid compartments; a pump; a compressible oil coalescing and removal unit; and if needed a vertical or horizontal polishing media unit; wherein fluid passed into said FPSO fluid compartments is pumped via said pump into said compressible oil coalescing and removal unit for oil coalescing and removal; said fluid if needed is then passed into said vertical or horizontal polishing unit; and wherein water derived from said fluid from FPSO fluid compartments is pumped via said compressible oil coalescing and removal unit for oil coalescing and removal; said fluid if needed is then passed through said vertical or horizontal polishing media unit and is discharged and oil derived from said process is returned to user for further use.

### Produced Water Treatment Subsummary

In several embodiments of the present invention, the fluids from single or multiple wells from oil and gas production are sent to a three-phase separation vessel to release the lighter hydrocarbons gas phase, heavier hydrocarbons oil phase, and water and solids. The bulk of the heavy hydrocarbons and most of the light hydrocarbons will be removed in this separation vessel. The remaining hydrocarbons, typically ranging in concentrations from 200 mg/L to 2,000 mg/L, depending on the emulsified state of the hydrocarbons, will be sent to a lower pressure multipurpose separations vessel (this can be either a pressure vessel or an atmospheric vessel).

In some embodiments of the present invention, during operation, the invention is a process that removes solids and hydrocarbons from produced water from oil and gas production. The oil coalescing and removal vessel will receive water containing solids and hydrocarbons; the hydrocarbons can be free or emulsified in the water.

### Compressable Coalesecing Media Subsummary

The oil coalescing and removal vessel can receive water containing solids and hydrocarbons. The hydrocarbons can be free or emulsified in the water. During the oil coalescing, the media is in a compressed state; different compressions allow or pin point micron size of oil droplets, but the more compression sacrifices surface area. The hydrocarbons are removed by flowing the oily water though a media consisting polymeric fiber balls the polymer attracts the oil and promotes coalescing. Once, the oil droplets have increased in size, the velocities of the fluid flowing through the media will push the large oil droplets through and out of the media where it will float to the top of the vessel. During the cleaning of the media, after the media is saturated the media is decompressed and agitated to allow flushing of the contaminates solids out from the oil coalescing media during cleaning process.

### Slop Tank Water Treatment Subsummary

In some embodiments, the water from the slop tanks will be pumped through an oil coalescing and removal vessel which will receive water containing solids and hydrocarbons; the hydrocarbons can be free or emulsified in the water.

### Deck Drainage Treatment Subsummary

In several embodiments, the water from the deck drainage holding tank will be pumped through the oil coalescing and removal vessel and will receive water containing solids and hydrocarbons. The hydrocarbons can be free or emulsified in the water.

### Produced Oil Wet Solids Removal Subsummary

In some embodiments of the present invention, during operation, the invention is a process that removes solids and hydrocarbons from produced water from oil and gas production. The oil coalescing and removal vessel will receive water containing oil wet solids and hydrocarbons; the hydrocarbons can be free or emulsified in the water.

### BRIEF DESCRIPTION OF THE DRAWINGS

For a more complete understanding of the present disclosure and the advantages thereof, reference is now made to the following descriptions to be taken in conjunction with the accompanying drawings describing specific embodiments of the disclosure, wherein:

FIG. 1 is a flow diagram of another embodiment of the present invention for FPSO Slop Water treatment.

FIG. 2 illustrates an alternative embodiment for deck drainage.

FIG. 3 illustrates an alternative embodiment a of the present invention for EOR Polymer Flood and ASP treatment.

FIG. 4 illustrates an embodiment of the present invention for the treatment of produced water.

FIG. 5 illustrates an embodiment of the present invention for the treatment of produced water.

### DETAILED DESCRIPTION

One or more illustrative embodiments incorporating the invention disclosed herein are presented below. Applicant has created a revolutionary industrial water cleaning process, system and method.

In the following description, certain details are set forth such as specific quantities, sizes, etc. so as to provide a thorough understanding of the present embodiments disclosed herein. However, it will be evident to those of ordinary skill in the art that the present disclosure may be practiced without such specific details. In may cases, details concerning such considerations and the like have been omitted inasmuch as such details are not necessary to obtain a complete understanding of the present disclosure and are within the skills of persons of ordinary skill in the relevant art.

Referring to the drawings in general, it will be understood that the illustrations are for the purpose of describing particular embodiments of the disclosure and are not intended to be limiting thereto. Drawings are not necessarily to scale and arrangements of specific units in the drawings can vary.

While most of the terms used herein will be recognizable to those of ordinary skill in the art, it should be understood, however, that when not explicitly defined, terms should be interpreted as adopting a meaning presently accepted by those of ordinary skill in the art. In cases where the construction of a term would render it meaningless or essentially meaningless, the definition should be taken from Webster's Dictionary, 11th Edition, 2008. Definitions and/or interpretations should not be incorporated from other patent applications, patents, or publications, related or not, unless specifically stated this specification or if the incorporation is necessary for maintaining validity.

Certain terms are used in the following description and claims to refer to particular system components. As one skilled in the art will appreciate, different persons may refer to a component by different names. This document does not intend to distinguish between components that differ in name but not function. The drawing figures are not necessarily to scale. Certain features of the invention may be shown exaggerated in scale or in somewhat schematic form, and some details of conventional elements may not be shown, all its the interest of clarity and conciseness.

Although several preferred embodiments of the present invention have been described in detail herein, the invention is not limited hereto. It will be appreciated by those having ordinary skill in the art that various modifications can be made without materially departing from the novel and advantageous teachings of the invention. Accordingly, the embodiments disclosed herein are by way of example. It is to be understood that the scope of the invention is not to be limited thereby.

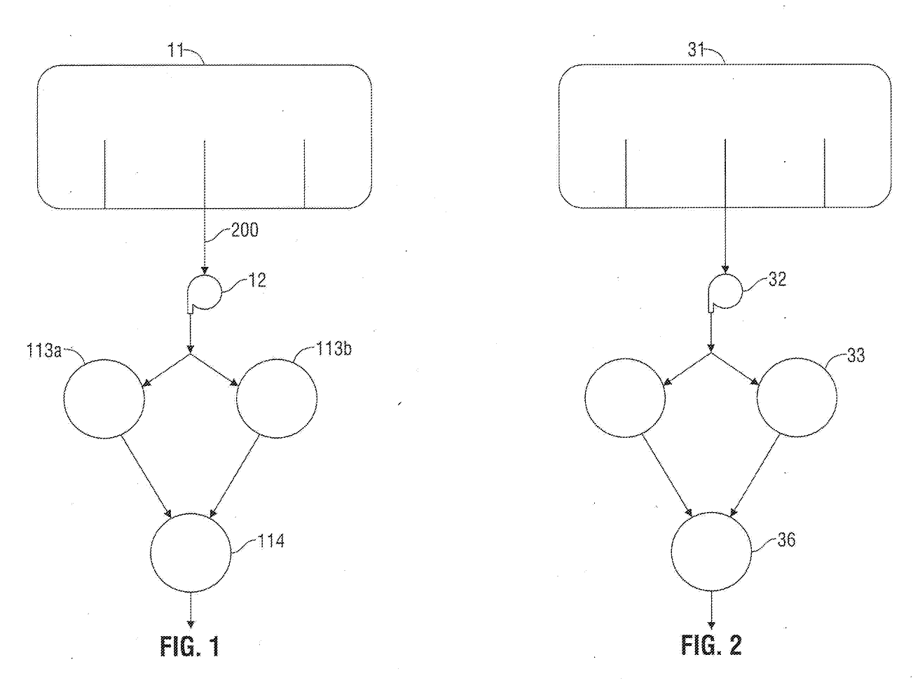

FIG. 1 shows and alternative FPSO slop water treatment embodiment. In this embodiment, fluid leaves FPSO fluid compartment 11. The contaminated water 200 from one of the fluid compartments 11 is pumped via pump 12 into either compressible oil coalescing and removal unit 113a or 113b, for compression oil coalescing and removal. After treatment in removal units 113a or 113b the treated water if needed is then sent into vertical or horizontal coalescing media unit 114 so that oil 300 (300 not shown on drawing) is then recycled for use.

The water from the slops tank will be pumped through the compressible oil coalescing and removal vessel 113a and or 113b that will receive water containing solids and hydrocarbons. The hydrocarbons can be free or emulsified in the water. During the removal of the hydrocarbons, the media, is in a compressed state; different compressions allow for finer oil droplet removal but the more compression sacrifices surface area. During the cleaning of the media, after the media is saturated, the media is decompressed and agitated to allow flushing of the contaminates out from the oil coalescing media. The hydrocarbons are removed by flowing the oily water though a media consisting of polymeric fiber balls where the polymer attracts the oil and promotes coalescing. Once the oil droplets have increased in size the velocities will push the large oil droplets through and out of the media where it will float to the top of the vessel. The clean water will be discharged from the side of the hydrocarbon removal vessel.

FIG. 2 illustrates an alternative embodiment for deck drainage treatment. As shown, water from one of the deck drainage compartments 31 will be pumped by pump 32 (if pressure boost is needed) into compressible solids filter 33a & 33b. If needed the water will then flow into said vertical or horizontal polishing unit 36 and will then be discharged. The oil that is coalesced will be separated and returned to client.

In several embodiments, the water to be treated will flow into a vessel up stream of the compressible coalescing media 33. The water will flow through the coalescing media 33 in a compressed state where the solids will be removed and the oil will be coalesced. The coalesced oil will separate by gravity separation alone or with micro bubbles to enhance the separation. The oil will be skimmed and the water will be removed from the side of the vessel.

In several embodiments, vertical or horizontal polishing unit 36 is designed to remove the residual oil present in the fluids. The fluid with free and emulsified organics will flow from the inside the inner core, through the media and out the outer core. The organics will be coalesced to form large oil droplets so that they will separate from the water and float to the top of the vessel or container the fluid is flowing into. The oil drops are large enough to separate from the water and will not re-disperse into the water. The vertical or horizontal polishing unit 36 with canisterized media in between that the fluid flows through. This media is a highly-compressed to a specific hydraulic pressure and consists of an exact blend of fibers and proprietary polymers. The hydrocarbons are removed by flowing the oily water though a media consisting of a polymer and fiber where the polymer attracts the oil and promotes coalescing. Once the oil droplets have increased in size, the velocities will push the large oil droplets through and out of the media where it will float to the top of the vessel. The clean water will be discharged from the bottom of the hydrocarbon removal vessel.

The water from the deck drainage holding tank will be pumped through the oil coalescing and removal vessel will receive water containing solids and hydrocarbons. The hydrocarbons can be free or emulsified in the water. During the removal of the solids the media is in a compressed state; different compressions allow for finer oil droplet removal but the more compression sacrifices surface area. During the cleaning of the media, after the media is saturated, the media is decompressed and agitated to allow flushing of the contaminates out from the filtration media. The hydrocarbons are removed by flowing the oily water though a media consisting of a polymeric fiber balls where the polymer attracts the oil and promotes coalescing. Once the oil droplets have increased in size the velocities will push the large oil droplets through and out of the media where it will float to the top of the vessel and are separated.

FIG. 3 illustrates an alternative embodiment of the present invention for EOR Polymer Flood and ASP treatment. As shown, water from one of the multiple water sources 41 will be pumped by pump 42 (if pressure boost is needed) into compressible oil coalescing filter 43. The water will then flow into vertical or horizontal polishing unit 46 and will then be discharged. The oil that is coalesced will be separated and returned to client.

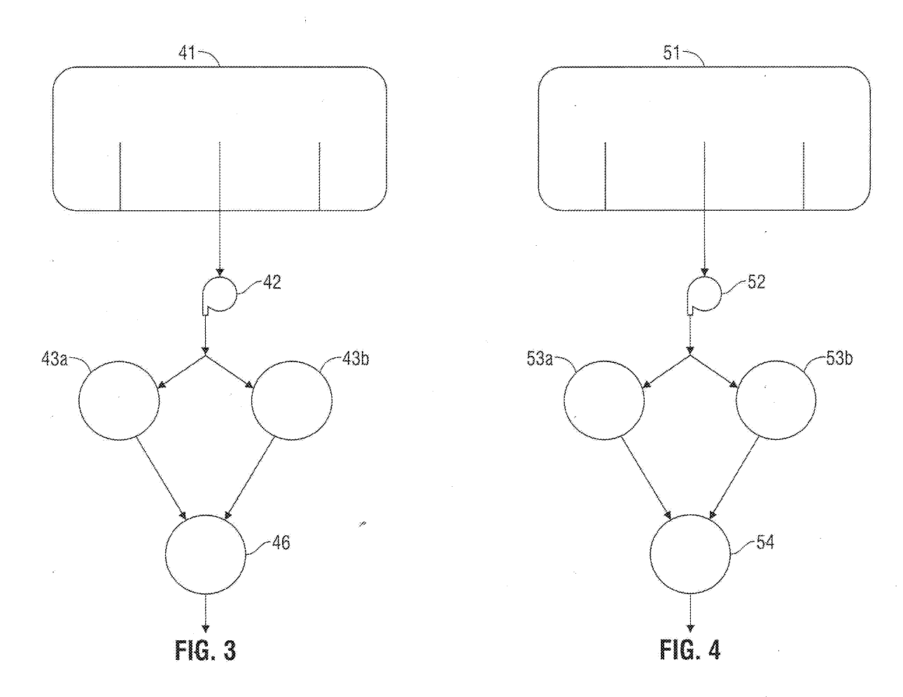

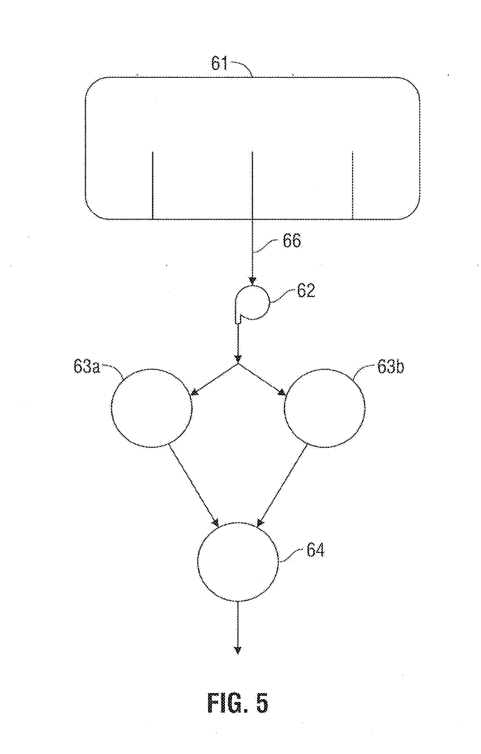

FIG. 4 illustrates an embodiment of the present invention for the treatment of produced water. As shown, water from one of the multiple fluid sources will be pumped by pump 52 (if pressure boost is needed) into one of the compressible oil coalescing media 53a and 53b. The water will then flow into vertical or horizontal polishing unit 54 and will then be discharged. The oil that is coalesced will be separated and returned to client.

FIG. 5 illustrates on embodiment of the present invention for the treatment of water oil wet solids. As shown, fluid 66 is housed in a separator, bulk oil removal unit, or flotation unit 61 or any other tank that may contain said fluids. This fluid 66 is then pumped out of unit 61 and into a compressible oil coalescing filter 63 to remove the oil and wet solids.

As shown in FIGS. 1-5, the fluids from single or multiple wells from oil and gas production are sent to a three-phase separation vessel 1 to release the lighter hydrocarbons gas phase heavier hydrocarbons oil phase, and water and solids. The bulk of the heavy hydrocarbons and most of the light hydrocarbons will be removed in this vessel 1.

While preferred embodiments have been shown and described, modifications thereof can be made by on skilled in the art without departing from the scope or teaching herein. The embodiments described herein are exemplary only and are not limiting. Many variations and modifications of the system and apparatus are possible and will become apparent to those skilled in the art once the above disclosure is fully appreciated. For example, the relative dimensions of various parts, the materials from which the various parts are made, and other parameters can be varied.

What is claimed is the following:

1. A system for treating slop water comprising:
FPSO fluid compartments;
a pump;
a compressible compressible oil coalescing and removal in and
a vertical or horizontal polishing unit; wherein
fluid passed into said FPSO fluid compartments is pumped via said pump into said compressible oil coalescing and removal unit for oil coalescing, removal; said fluid, then passing into either said vertical or horizontal polishing unit; and wherein
water derived from said fluid from FPSO fluid compartments that is pumped via said compressible oil coalescing and removal unit for oil coalescing and removal; said fluid is then passed from either said vertical or horizontal polishing media unit and is discharged and oil derived from said process is returned to user for further use.

2. A system for treating deck drainage comprising:
FPSO fluid compartments;
a pump;
a compressible oil coalescing and removal unit; and
a vertical or horizontal polishing media unit; wherein
fluid passed into said FPSO fluid compartments is pumped via said pump into said compressible oil coalescing, and removal unit for oil coalescing and removal; said fluid is then passed into said either said vertical or horizontal polishing unit; and wherein
water derived from said fluid from FPSO fluid compartments that is pumped via said compressible oil coalescing and removal unit for oil coalescing and removal; said fluid is then passed into either said vertical or horizontal polishing media unit and is discharged and oil derived from said process is returned to user for further use.

3. A system for treating FOR Polymer Flood & ASP comprising:
a tank or vessel;
a pump;
a compressible oil coalescing and removal unit; and
if needed a vertical or horizontal polishing media unit; wherein
fluid passed into said a tank or vessel is pumped via said pump into said compressible oil coalescing and removal unit for oil coalescing and removal; said fluid is then passed into either said vertical or said horizontal polishing unit; and wherein
water derived from said fluid from a tank or vessel that is pumped via said compressible oil coalescing and removal unit for oil coalescing and removal; said fluid if needed is then passed from said vertical or horizontal polishing media unit and is discharged and oil derived from said process is returned to user for further use.

4. A method for treating slop water comprising the steps of:
pumping fluid out of FPSO fluid compartments into a compressible oil coalescing and removal unit for oil coalescing and removal; and
passing said fluid, if needed, into said vertical or horizontal polishing unit.

5. A method for treating deck drainage comprising:
pumping fluid from FPSO fluid compartments into a compressible oil coalescing and removal unit for oil coalescing and removal; and,
if needed, passing said fluid into either said vertical or horizontal polishing unit.

6. A method for treating FOR Polymer Flood & ASP comprising the steps of:
pumping fluid from a tank or vessel into said compressible oil coalescing and removal unit for oil coalescing and removal; and,
passing said fluid into said vertical or horizontal polishing unit.

7. A system for treating slop water comprising:
a fluid containment unit;
a pump; and
a compressible oil coalescing and removal unit; wherein
fluid passed into said fluid containment unit is pumped via said pump into said compressible oil coalescing and removal unit for oil coalescing and removal; and wherein oil wet solids derived from said fluid from fluid containment unit that is pumped via said compressible oil coalescing and removal unit for oil wet solids removal.

8. A method for treating slop water comprising the steps of:
pumping fluid out of fluid containment unit into a compressible oil coalescing and removal unit for oil coalescing and removal.
